(19) United States
(12) Patent Application Publication
(10) Pub. No.: US 2025/0342167 A1
(43) Pub. Date: Nov. 6, 2025

(54) OBJECT STORAGE SERVICE IMPLEMENTING A DISTRIBUTED STREAMING PLATFORM

(71) Applicant: Confluent, Inc., Mountain View, CA (US)

(72) Inventors: Mahesh Balakrishnan, Sammamish, WA (US); Lucas Bradstreet, Singapore (SG); Gardner Vickers, Miami, FL (US)

(21) Appl. No.: 19/196,558

(22) Filed: May 1, 2025

Related U.S. Application Data
(60) Provisional application No. 63/642,144, filed on May 3, 2024.

(51) Int. Cl. G06F 16/25; G06F 16/28

(52) U.S. Cl. CPC G06F 16/256; G06F 16/289

(57) ABSTRACT

The described technology pertains to a distributed computing environment, specifically implementing a streaming protocol on a scalable object storage service. The technical problem addressed is the high computing resource demand of distributed streaming platforms. The solution involves separating content from location metadata, allowing centralized, scalable storage of metadata. Brokers store content in object storage services based on specific metrics, such as fast read/write times or greater storage capacity. A background platform remaps metadata sequences based on logical timestamps, optimizing data retrieval. This system enhances the efficiency of computing resources by reducing the load on brokers and improving data access speeds. A use can be in cloud computing systems for efficient content streaming and storage management.

### CROSS-REFERENCE TO RELATED APPLICATION

This patent application claims the benefit of U.S. Provisional Patent Application No. 63/642,144, filed May 3, 2024, entitled “OBJECT STORAGE SERVICE IMPLEMENTING A DISTRIBUTED STREAMING PLATFORM”, which is incorporated by reference herein in its entirety.

### TECHNICAL FIELD

Examples relate generally to distributed computing environments and, more particularly, but not by way of limitation, to implementing a streaming protocol on a scalable storage service.

### BACKGROUND

Cloud-computing systems have grown in popularity as a method of providing computer implemented resources. A service provider can provide services to various end-users based on the needs of the various end-users. These services can include streaming content to end-users using various streaming protocols. An example of a streaming protocol that can be used is the Apache™ Kafka™ streaming platform.

Apache™ Kafka™ is a distributed streaming platform that works in a cluster where each node in the cluster is a broker. Content producers provide content to an individual broker within the cluster. When a consumer desires the content, the consumer can message with the broker to receive the content. However, by virtue of having multiple brokers, which, in some instances, are partitioned by topic, this type of configuration requires a great amount of computing resources.

Examples relate to a distributed platform that allows for separation of content from data that describes a location of the content. The separation can allow for centralized storage of content location information where the centralized location can be scalable. Brokers can store content at object storage services based on needs associated with the data. Thus, if a first content producer requires fast read and write times for first content, a first broker can store the first content at a first object storage service that allows for fast read and write times. If a second content producer does not require fast read and write times, a second broker can store the second content at a second object storage service different from the first object storage service.

The second broker can provide a second pointer relating to the second location of the second content to a background platform at a first time T₁ and having a first logical timestamp. The first broker can provide a first pointer relating to the first location of the first content to a background platform at a second time T₂ and having a second logical timestamp. The background platform can remap the first content and the second content based on the first logical timestamp and the second logical timestamp.

### BRIEF DESCRIPTION OF THE DRAWINGS

Various ones of the appended drawings merely illustrate example examples of the present disclosure and should not be considered as limiting its scope.

FIG. 1 illustrates a computing environment in which a distributed platform can operate on an object storage service where a background platform that is separate from the distributed platform along with the object storage service can perform functions on content stored at the object storage service, according to some examples.

FIGS. 2A-2C show metadata having pointers and timestamps associated with the content stored at the object storage service of FIG. 1, according to some examples.

FIG. 3 illustrates a metadata plane of the distributed streaming platform of FIG. 1, according to some examples.

FIG. 4 illustrates a sequence log of the metadata of FIGS. 2A-2C when the metadata of FIGS. 2A-2C has been remapped, according to some examples.

FIG. 5 illustrates a computing environment in which a distributed platform can operate on an object storage service where a background platform that is separate from the distributed platform along with the object storage service can perform functions on data stored at the object storage service, according to some examples.

FIG. 6 is a method of operating the distributed platforms of FIG. 1, according to some examples.

FIG. 7 is a block diagram illustrating architecture of software used to implement displaying an interactive user interface, according to some examples.

FIG. 8 shows a machine as an example computer system with instructions to cause the machine to implement displaying an interactive user interface, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

As mentioned above, a distributed streaming platform works in a cluster where each node in the cluster is a broker. By virtue of having multiple brokers, which, in some instances, are partitioned by topic, this type of configuration requires a great amount of computing resources. If the distributed streaming platform could be offloaded to an object storage service that provides storage of large amounts of data, such as a data lake, this could reduce the amount of computing resources. Examples of an object storage service include the Amazon™ Simple Storage Service (Amazon S3™). However, implementation of a distributed streaming platform on an object storage service can result in a distributed streaming platform that is extremely slow.

Accordingly, what is needed is a method to implement a distributed platform that is separate from an object storage service without decreasing speeds at which the distributed platform can operate. Examples address this need by providing a background platform that can receive a sequence of data associated with content at an object storage service, remap the sequence of data, and provide the sequence of data to a requestor, such as a broker. The sequence of data can relate to pointers indicating where the content is stored at the object storage service. The sequence of data can be associated with a logical timestamp that can relate to when a broker sent the sequence of data to the background platform.

The background platform can remap the sequence of data based on when the background platform received the sequence of data. The remapped sequence of data can be stored as metadata. When the background platform receives a request from a broker for the content, the background platform can provide the metadata to the broker. The broker can then use the metadata to access the content at the object storage service and provide the content to a requestor of the content.

Alternatively, using the metadata, the background platform can retrieve the content from the object storage service and provide the content to the broker. Storing the metadata at the background platform while the content associated with the metadata is stored at the object storage service can allow for separation of the metadata from the associated content.

Examples improve the functioning of computing devices. Different content can have different storage requirements. For example, a first type of content may require faster read/write times while a second type of content may require greater storage capacity. Therefore, the first type of content should be stored at a database that supports faster read/write times while the second type of content should be stored at a database that supports greater storage capacity. Furthermore, in order to access the first and second types of content, pointers, which can be stored as metadata, should be recorded and stored. However, if different types of content having different storage requirements are stored at different locations, locating the metadata having the pointers can prove time and computing resource intensive, thereby adversely affecting the functioning of computing devices.

Examples address this problem by separating the content and the metadata. In particular, the metadata having pointers to where content is stored can be centrally located such that requestors can turn to the central location to request metadata associated with content stored remotely from the central location. Thus, the central location of the metadata can reduce computing resources when determining where, exactly, content is stored.

Furthermore, if something adverse should happen to the storage location, since the metadata is siloed from the storage location, a determination of content stored at the storage location can be easily determined. Again, the central location of the metadata can reduce computing resources when determining what content is stored at different locations.

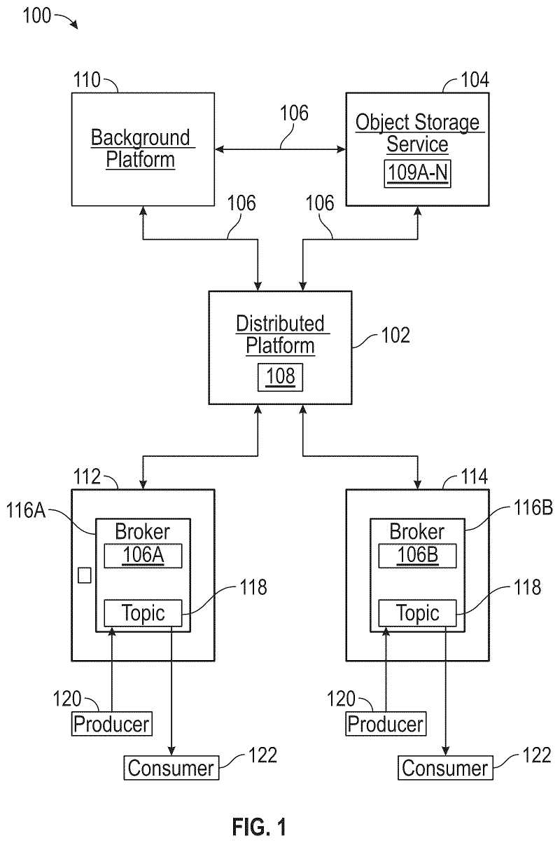

Now making reference to FIG. 1, a computing environment 100 where Application Programming Interfaces (APIs) of a distributed platform 102 that can be used to stream processes, applications, and data is shown. In one embodiment, the distributed platform can be a distributed streaming platform, such as Apache Kafka®. The distributed platform 102 can interact with an object storage service 104 to push metadata 106 to the object storage service 104 and retrieve the metadata 106 from the object storage service 104 in response to a user request. The distributed platform 102 can be implemented directly on the object storage service 104 in a decoupled manner.

The object storage service 104 can incorporate various types of storage types in order to account for the needs of content being stored at the object storage service 104. If the content requires fast read/write times, storage types having high performance, such as DynamoDB™, can be implemented at the object storage service 104. If read/write times are less of a concern and greater scalability and storage space is required, Amazon S3™ can be implemented at the object storage service 104 and content can be stored using Amazon S3™. In these scenarios, the object storage service 104 can be distributed across several platforms but is shown as a single platform for ease of discussion.

While a single object storage service 104 is described herein as being accessed by the distributed platform 102 and brokers, separate object storage services 104 can be accessed by the distributed platform 102 and brokers. For example, a first object storage service can include DynamoDB™ while a second object storage service can include Amazon S3™. If brokers require Amazon S3™ while the distributed platform 102 requires DynamoDB™, brokers can access the second object storage service while the distributed platform 102 can access the first object storage service.

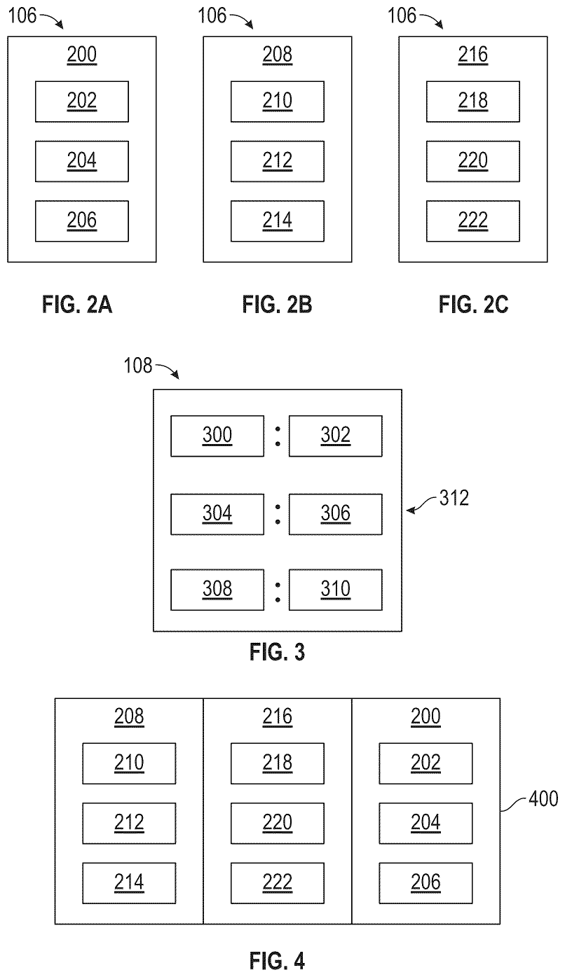

In further examples, the object storage service 104 can generate the metadata 106 when content 109A-109N is stored at the object storage service 104. Making reference to FIGS. 2A-2C, metadata 200, which can be generated by the object storage service 104 when a broker provides the content 109A to the object storage service 104, can include pointers 202 and 204 and a timestamp 206. In addition, metadata 208, which can be generated by the object storage service 104 when a broker provides the content 109B to the object storage service 104, can include pointers 210 and 212 along with a timestamp 214. Moreover, metadata 216, which can be generated by the object storage service 104 when a broker provides the content 109C to the object storage service 104, can include pointers 218 and 220 and a timestamp 222.

The pointers 202, 204, 210, 212, 218, and 220 can indicate where at the object storage service 104 the corresponding content 109A-109C can be found. The pointers 202, 204, 210, 212, 218, and 220 can indicate the number of items at the location. The pointers 202, 204, 210, 212, 218, and 220 can be used by a broker to locate the content 109A-109C when a request for the content 109A-109C is received by the broker. The timestamps 206, 214, and 222 can correspond to when a broker sent the metadata 200, 208, and 216 to the background platform 110.

The computing environment 100 can also implement a metadata plane 108 that can create, among other features, the metadata 106 for the content 109A-109N stored at the object storage service 104. The metadata 106 can have pointers that can be used to order the content. Thus, when an API of the distributed platform 102 retrieves the metadata 106 from the object storage service 104, the pointers can be used to order the metadata 106 prior to providing the metadata 106 to a requestor. The metadata plane 108 can be on a separate plane than that of the distributed platform 102 that is run on a separate machine. The metadata plane 108 can be rebalanced using any technique, such as a Raft algorithm or a Paxus algorithm. For rebalancing and/or sharding, techniques that can be used can include Amazon™ DynamoDB™, Google™ Slicer, and the like.

The metadata plane 108 can be a storage system having a key value store 312, as shown with reference to FIG. 3. The key value store 312 can include key value pairs 300-310. The keys 300, 304, and 308 can correspond to data streams that comprise the metadata 106. The values 302, 306, and 310 can correspond to pointers indicating where ones of the keys 300, 304, and 308 are stored at the object storage service 104.

The computing environment 100 can also include a background platform 110 that can perform a number of functions on the metadata 106. The background platform 110, which can be a background plane, can standalone and be separate from the other components in the computing environment 100. Moreover, the background platform 110 can be logically separate from each of the distributed platform 102 and the object storage service 104. The background platform 110 can be implemented by the distributed platform 102 and interact with the object storage service 104. Alternatively, the background platform 110 can be siloed from the object storage service 104.

The computing environment 100 can also include a source/destination cluster 112 along with a source/destination cluster 114. The source/destination clusters 112 and 114 can be communicatively coupled with the distributed platform 102 via one or more networks (not shown). The networks can include, for example, a wide area network (WAN), the Internet, or another packet-switched data network.

The source/destination clusters 112 and 114 can comprise one or more brokers 116A and 116B (collectively, brokers 116). In some cases, the brokers 116 can be a network of machines (e.g., servers). In other cases, the brokers 116 can be containers running on virtualized servers on processors in a datacenter, or a combination of the machines and containers.

The brokers 116 can be configured to run a broker process in order to handle requests from clients and keep data replicated. Specifically, each broker 116 can host a plurality of partitions associated with topics 118, handle incoming requests to write new events (e.g., a fact that happened) to those partitions, read events from the partitions, and/or handle replication of partitions. Each topic is a unit of organization that groups similar records/data together (e.g., by category). Thus, each topic 118 can act as container to hold similar events. The partition can be the smallest storage unit holding a subset of records or data for a particular topic 118.

Each broker 116 can have a network server that accepts connections on one or more listeners and allocates each connection to a processor from its pool of processors. A selector associated with the assigned processor handles all traffic on the connection using non-blocking input/output. The state of each connection is stored in a channel managed by the selector.

In examples, each of the brokers 116A and 116B can read the content 109A-N from the object storage service 104. Moreover, each of the brokers 116A and 116B can write the content 109A-N to the object storage service 104. The brokers 116A and 116b can write unorganized/unsequenced data to the object storage service 104. Additionally, the brokers 116A and 116b can write the metadata 200 to the distributed platform 102. The metadata 200 can reference the unorganized/unsequenced data at the object storage service 104.

The distributed platform 102 can organize and sequence the metadata 200 received by the broker by writing to the object store in a log-structured manner as described herein. Using this log of events, the distributed platform 102 can construct an index that has the unorganized/unsequenced data. The brokers 116A and 116B can then query the distributed platform 102 using the index constructed by the distributed platform 102 to locate the previously written unorganized/unsequenced data.

Clients (e.g., producer 120, consumer 122) can connect to the brokers 116 on one of the advertised listeners. The clients can be configured with security configurations to authenticate with the broker 116 for the security protocol used by the listener. A network client used by the client can have its own selector that establishes connections and processes traffic to/from the brokers 116. A state of each connection is stored in a channel managed by the selector of the network client.

For a typical flow (e.g., to obtain metadata), the client can establish a connection to the broker 116 and initiates authentication flow. If authentication fails, the connection is terminated by the broker 116. Otherwise, the channel moves to a ready state and the broker 116 starts processing requests arriving on the channel. On each channel, the client sends requests and the broker 116 can process a request, sends a response to the request, and then reads the next request.

The producer 120 can be configured to produce new data and send the new data (e.g., new records) to the broker 116A in the source/destination cluster 112. In some embodiments, the producer 120 can comprise a client application that is a source (e.g., publishes, streams) of the events. In some embodiments, the producer 120 can stream or publish the new data to the broker 116A in real-time.

The consumer 122 can be configured to consume data (e.g., batches of records) from one or more topics 118 of the broker 116. More particularly, the consumer 122 can be an end-user or application that retrieves data from the source/destination clusters 112 or 114. In some embodiments, the consumer 122 can subscribe to respective topics 118 in order to read and process data from the respective topics 118.

When the producer 120 provides content to the broker 116, the broker 116 can store the content at the object storage service 104. The object storage service 104 can create the metadata 106 and provide the metadata 106 to the broker 116. The broker 116 can then provide the metadata 106 to the background platform 110. Alternatively, the object storage service 104 can provide the metadata 106 directly to the background platform 110.

The background platform 110 can remap metadata 106 received from the brokers 116. As noted above, the metadata 106 can include the timestamps 206, 214, and 222, which can relate to when the brokers 116 sent the metadata 106 to the background platform 110. In scenarios where the timestamp 206 indicates that one of the brokers 116 sent the metadata 200 before the metadata 208 and 216 was sent by the other brokers 116 and the timestamp 214 indicates that the metadata 208 was sent before the metadata 216 was sent, the metadata 200 may not arrive at the background platform 110 until after the metadata 208 and 216. For example, latency issues may exist when the metadata 200 was sent. Thus, the timestamp 206 can differ from a receipt time of the metadata 200 at the background platform 110.

Therefore, the background platform 110 first receives the metadata 208, then the metadata 216, and then the metadata 200 after the metadata 216. During a remapping process, the background platform 110 can reorder the metadata 200, 208, or 216 according to the sequence that the metadata 200, 208, and 216 was received by the background platform 110. Thus, during remapping, since the metadata 208 was received first, the metadata 216 received second, and the metadata 200 received third, the background platform 110 can remap the metadata 200, 208 and 216 to have a log sequence 400, as shown with reference to FIG. 4.

In addition to the remapping the metadata 106, the background platform 110 can scan the metadata 106 and catalog the metadata 106 in real time. The background platform 110 can also tag the metadata 106 depending on the needs of a requestor. For example, the background platform 110 can periodically or continually update the metadata 106 based on timestamps associated with the metadata 106. Thus, if a requestor is interested in portions of the metadata 106 from a time period T₁, the background platform 110 can tag those portions of the metadata 106 that are within the time period T₁ as being in the time period T₁. For portions of the metadata 106 that are not within the time period T₁, such as portions of the metadata 106 that are within time periods T₂ and T₃, the background platform 110 can tag those portions of the data as being within the time periods T₂ and T₃. Based on tagging the data within different time periods, the background platform 110 can instruct the distributed platform 102 to overwrite the portions of the data within the time periods T₂ and T₃ with the portions of the metadata 106 that are within the period T₁.

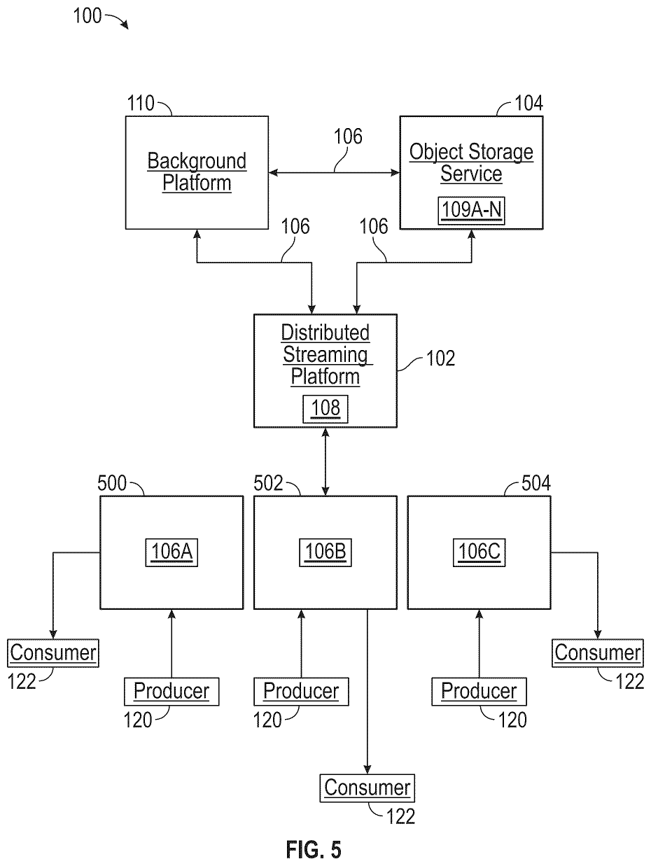

In further examples, the computing environment 100 can include a plurality of brokers 500-504, which can each correspond to a server or a plurality of servers that can receive the content 109A-109N from the producers 120 and receive requests for the content 109A-109N from the consumers 122, as shown with reference to FIG. 5. In addition, the brokers 500-504 can provide the content 109A-109N to the consumers 122 in response to the received requests. The background platform 110 can be separate from the brokers 500-504 such that the background platform 110 can be independent from the brokers 500-504.

The brokers 500-504 can store individual portions 106A-106C of the metadata 106. The computing environment 100 can include information regarding how to retrieve different portions 106A-106C of the metadata 106. The information can relate to how the metadata 106 can be into divided into the different portions 106A-106C and ones of the brokers 500-504 can be responsible for the different portions 106A-106C. Thus, the broker 500 can be responsible for the data portion 106A, the broker 502 can be responsible for the data portion 106B, and the broker 504 can be responsible for the data portion 106C.

In further examples, all of the information regarding how to retrieve the metadata 106 can be replicated on all of the brokers 500-504. Moreover, a sharding or partitioning technique can be used where two sets of the information regarding how to retrieve the metadata 106 can be on two of the brokers 500-504. Thus, replication, partitioning, and rebalancing can be performed on the brokers 500-504 for the information regarding how to retrieve the metadata 106. The information regarding how to retrieve the metadata 106 can be replicated on the brokers 500-504 using any known technique.

Each of the brokers 500-504 can interact with the requestors by receiving the metadata 106 from requestors. In addition, each of the brokers 500-504 can receive requests for the metadata 106 from requestors. By having the background platform 110 separate from the brokers 500-504 and operating independently from the brokers 500-504 performing the operations detailed above, the brokers 500-504 are not encumbered by the functionality of the background platform 110. Thus, computing resources required by the brokers 500-504 can be decreased. Moreover, a speed with which the brokers 500-504 can serve requests associated with the metadata 106 can increase, thereby increasing overall performance of the computing environment 100.

By virtue of having the plurality of brokers 500-504, responsibility associated with serving requests for the metadata 106 can be evenly distributed. The brokers 500-504 can be scalable where portions of the metadata 106 can be evenly distributed across the brokers 500-504 such that one of the brokers 500-504 does not become overloaded while the others of the brokers 500-504 remain underutilized. The assignment of portions of the metadata 106A-106C to the brokers 500-504 can also be stored at the object storage service 104. Thus, when a request is received, a determination can be made regarding which of the brokers 500-504 is responsible for the requested portion of the metadata 106.

When one of the brokers 500-504 receives a request for the metadata 106, the broker can access the metadata plane 108 and search ones of the keys 300, 304, and 308 that corresponds to the request. The broker can then access one of the values 302, 306, and 310 that is associated with the one of the keys 300, 304, and 308 that corresponds to the request and then initiate access of data associated with the request from the object storage service 104. Therefore, the broker can do an initial lookup of the keys 300, 304, and 308 and then a subsequent lookup using the one of the values 302, 306, and 310.

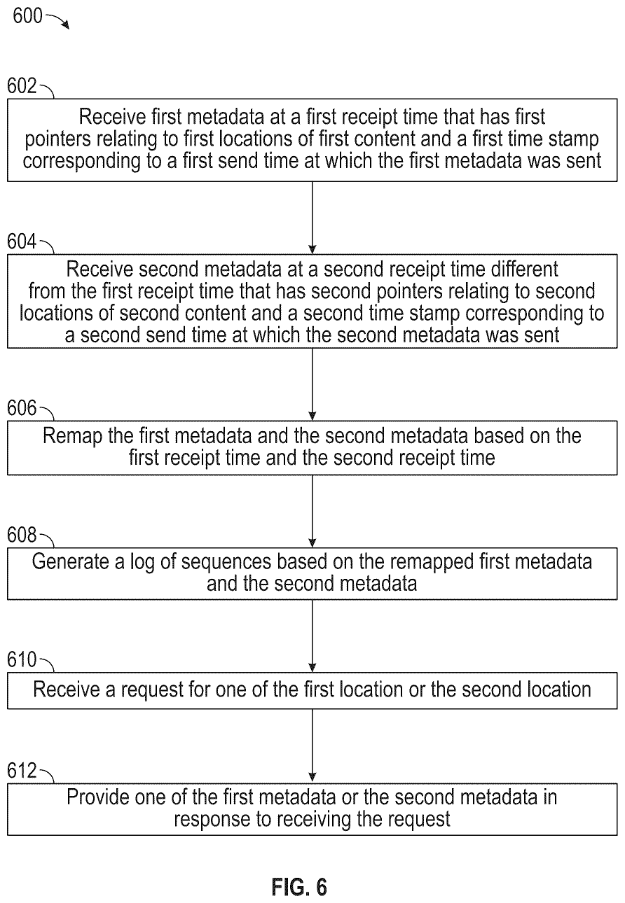

Now making reference to FIG. 6, a method 600 for operating the distributed platform 102 having the object storage service 104, the distributed platform 102 communicatively coupled with the object storage service 104, and the background platform 110 communicatively coupled with the object storage service 104 is shown. The method 600 can be performed by any elements of the computing environment 100 such as the background platform 110 or any other type of device having a processor and memory.

During an operation 602, the background platform 110 can receive first metadata, such as the metadata 200, at a first receipt time. The first metadata can include first pointers, such as the pointers 202 and 204, which can relate to where first content, such as the content 109A, is stored at the object storage service 104. The first metadata can also include a first timestamp, such as the timestamp 206, which can relate to when a broker, such as the broker 116A, sent the first metadata to the background platform 110.

During the operation 602, the first metadata can be stored at the background platform 110. Moreover, the content 109A may require greater storage capacity. Thus, the first content 109A can be stored using Amazon S3™. Since the first metadata 200 is stored at the background platform 110 and the first content 109A is stored at the object storage service 104 and the background platform 110 can be siloed from the object storage service 104, the first metadata 200 can be remotely stored from the first content 109A.

During an operation 604, the background platform 110 can receive second metadata, such as the metadata 208, at a second receipt time that is different from the first receipt time. The second metadata can include second pointers, such as the pointers 210 and 212, that can relate to where second content, such as the content 109B, is stored at the object storage service 104. The second metadata can also include a second timestamp, such as the timestamp 214, which can relate to when a broker, such as the broker 116B, sent the second metadata to the background platform 110.

During the operation 604, the second metadata can be stored at the background platform 110. Furthermore, the second content 109B may require faster read/write capacity. Thus, the second content 109B can be stored using DynamoDB™. Since the second metadata 208 is stored at the background platform 110 and the second content 109B is stored at the object storage service 104 and the background platform 110 can be siloed from the object storage service 104, the second metadata 208 can be remotely stored from the second content 109B.

After the first and second metadata are received, an operation 606 can be performed where the first metadata and the second metadata can be remapped based on the first receipt time and the second receipt time. The first and second receipt times can be agnostic to the first and second send times. Thus, if the first send time occurs before the second send time, the second receipt time can occur before the first receipt time, as discussed above. During the operation 606, a determination is made that the background platform 110 received the second metadata before the first metadata. Thus, the background platform 110 can remap the first metadata and the second metadata such that the second metadata is before/ahead the first metadata.

When the first and second metadata are remapped, a log of sequences can be generated based on the remapped metadata during an operation 608. Here, the background platform 110 can generate the log sequence 400 where the metadata 208 can be ordered before the metadata 200 during the operation 608.

After the log sequence is generated during the operation 608, the background platform 110 can receive a request for one of the first locations or the second locations during an operation 610. In particular, the broker 504 may have received a request for the content 109A from the consumer 122. Thus, the broker 504 can send a request for the location of the content 109A to the background platform 110.

In response to receiving the request for one of the first location or the second location, the background platform 110 can provide one of the first metadata or the second metadata during an operation 612. In response to receiving the request for the location of the content 109A, the background platform 110 can send along the first metadata 200 to the broker 504 during the operation 612. The first metadata 200 can indicate the first content 109A is stored at the object storage service 104 using Amazon S3™. Thus, the broker 504 can retrieve the content 109A from the object storage service 104 and provide the content 109A to the consumer 122.

While the method 600 describes that the background platform 110 provides the metadata to the broker 504 and the broker 504 retrieves the content 109A from the object storage service 104, in further examples, the background platform 110 can directly retrieve the content 109A from the object storage service 104 using the metadata 200 instead of the broker 504 and provide the content 109A to the broker 504.

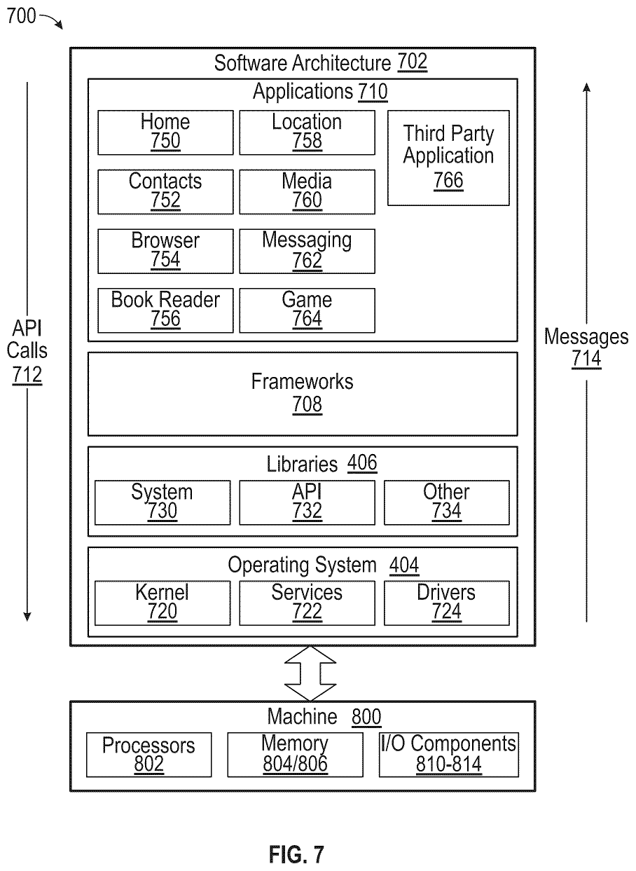

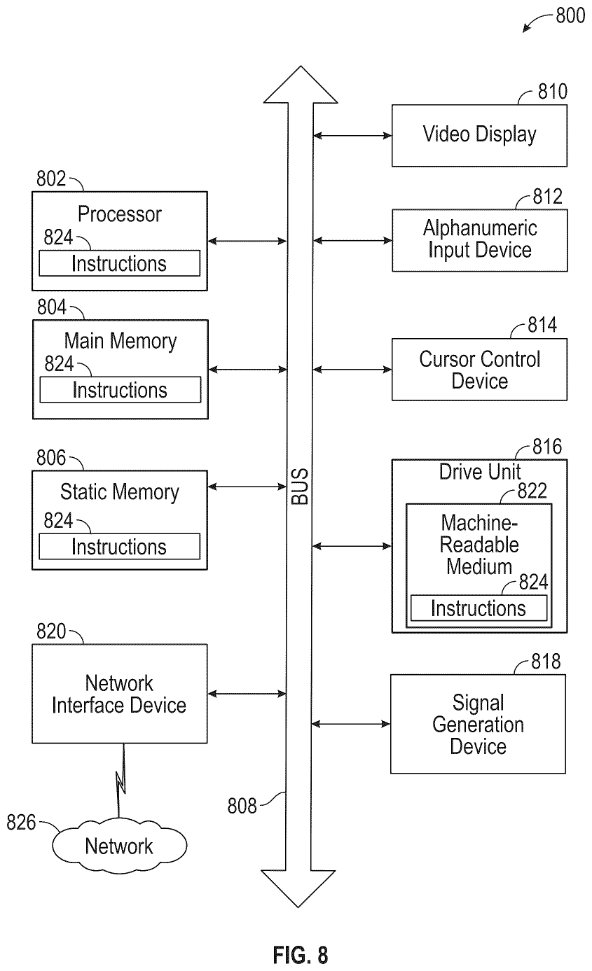

Any of the machines, databases, or devices shown in FIGS. 1-5 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 7 and 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIGS. 1 and 5 may be combined into a single machine, database, or device, and the functions described herein for any single machine, database, or device may be subdivided among multiple machines, databases, or devices. In examples, communication links between elements of the computing environment 100 are implemented via one or more data communication networks. These data communication networks may utilize any wired or wireless communication protocol and any type of communication medium. In some embodiments, the data communication networks are a combination of two or more data communication networks (or sub-networks) coupled to one another.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-5 are implemented in some embodiments in the context of a machine and an associated software architecture. The sections below describe representative software architecture and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, and the like. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the inventive subject matter in different contexts from the disclosure contained herein.

FIG. 7 is a block diagram 700 illustrating a software architecture 702, which may be installed on any one or more of the devices described above. FIG. 7 is merely a non-limiting example of a software architecture, and it will be appreciated that many other architectures may be implemented to facilitate the functionality described herein. The software architecture 702 may be implemented by hardware such as a machine 800 of FIG. 8 that includes a processor 802, memory 804 and 806, and I/O components 810-814. In this example, the software architecture 702 may be conceptualized as a stack of layers where each layer may provide a particular functionality. For example, the software architecture 702 includes layers such as an operating system 704, libraries 706, frameworks 708, and applications 710. Operationally, the applications 710 invoke application programming interface (API) calls 712 through the software stack and receive messages 714 in response to the API calls 712, according to some implementations.

In various implementations, the operating system 704 manages hardware resources and provides common services. The operating system 704 includes, for example, a kernel 720, services 722, and drivers 724. The kernel 720 acts as an abstraction layer between the hardware and the other software layers in some implementations. For example, the kernel 720 provides memory management, processor management (e.g., scheduling), component management, networking, and security settings, among other functionality. The services 722 may provide other common services for the other software layers. The drivers 724 may be responsible for controlling or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 706 provide a low-level common infrastructure that may be utilized by the applications 710. The libraries 706 may include system libraries 730 (e.g., C standard library) that may provide functions such as memory allocation functions, string manipulation functions, mathematic functions, and the like. In addition, the libraries 706 may include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 may also include a wide variety of other libraries 734 to provide many other APIs to the applications 710.

The frameworks 708 provide a high-level common infrastructure that may be utilized by the applications 710, according to some implementations. For example, the frameworks 708 provide various graphic user interface (GUI) functions, high-level resource management, high-level location services, and so forth. The frameworks 708 may provide a broad spectrum of other APIs that may be utilized by the applications 710, some of which may be specific to a particular operating system or platform.

In an example, the applications 710 include a home application 750, a contacts application 752, a browser application 754, a book reader application 756, a location application 758, a media application 760, a messaging application 762, a game application 764, and a broad assortment of other applications such as a third-party application 766. According to some examples, the applications 710 are programs that execute functions defined in the programs. Various programming languages may be employed to create one or more of the applications 710, structured in a variety of manners, such as object-orientated programming languages (e.g., Objective-C, Java, or C++) or procedural programming languages (e.g., C or assembly language). In a specific example, the third-party application 766 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 766 may invoke the API calls 712 provided by the mobile operating system (e.g., the operating system 704) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 8 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The machine 800, which can be a computer system, includes the processor 802 (e.g., a central processing unit (CPU), a graphics processing unit (GPU) or both), a main memory 804 and a static memory 806, which communicate with each other via a bus 808. The machine 800 may further include a video display unit 810 (e.g., a liquid crystal display (LCD) or a cathode ray tube (CRT)). The machine 800 also includes an alphanumeric input device 812 (e.g., a keyboard), a user interface (UI) navigation device (cursor control device) 814 (e.g., a mouse), a disk drive unit 816, a signal generation device 818 (e.g., a speaker) and a network interface device 820.

The drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the machine 800, the main memory 804 and the processor 802 also constituting machine-readable media. Instructions 824 may also reside within the static memory 806.

While the machine-readable medium 822 is shown in an example to be a single medium, the term “machine-readable medium” may include a single medium or multiple media (e.g., a centralized or distributed database, and/or associated caches and servers) that store the one or more instructions or data instructions 824. The term “machine-readable medium” shall also be taken to include any tangible medium that is capable of storing, encoding or carrying instructions 824 for execution by the machine and that cause the machine to perform any one or more of the methodologies of the present invention, or that is capable of storing, encoding or carrying data structures utilized by or associated with such instructions 824. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 824 for execution by the machine, and includes digital or analog communications signals or other intangible media to facilitate communication of such software.

Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

### Executable Instructions and Machine Storage Medium

The various memories and/or storage unit may store one or more sets of instructions and data structures (e.g., software) embodying or utilized by any one or more of the methodologies or functions described herein. These instructions, when executed by processor(s), cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

### Transmission Medium

In various examples, one or more portions of network, such as the network-based system may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. To further illustrate, a network or a portion of a network may include a wireless or cellular network, where a coupling may be a Code Division Multiple Access (CDMA) connection, a Global System for Mobile communications (GSM) connection, or another type of cellular or wireless coupling. In this illustration, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

Instructions may be transmitted or received over a network using a transmission medium via a network interface device and utilizing any one of a number of well-known transfer protocols (e.g., hypertext transfer protocol (HTTP)). Similarly, the instructions may be transmitted or received using a transmission medium via the coupling (e.g., a peer-to-peer coupling) to devices. The terms “transmission medium” and “signal medium” mean the same thing and may be used interchangeably in this disclosure. The terms “transmission medium” and “signal medium” shall be taken to include any intangible medium that is capable of storing, encoding, or carrying instructions for execution by a machine, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### Additional Examples

Example 1 is a distributed platform comprising: an object storage service; a distributed platform communicatively coupled with the object storage service; and a background platform communicatively coupled with the object storage service, the background platform comprising: at least one processor; and at least one memory comprising instructions that, when executed by the at least one processor, cause the at least one processor to perform operations comprising: receiving first metadata at the background platform at a first receipt time, the first metadata comprising: first pointers relating to first locations of first content stored at the object storage service; and a first timestamp corresponding to a first send time at which the first metadata was sent to the background platform; receiving second metadata at the background platform at a second receipt time different from the first receipt time, the second metadata comprising: second pointers relating to second locations of second content stored at the object storage service; and a second timestamp corresponding to a second send time at which the second metadata was sent to the background platform; remapping the first metadata and the second metadata based on the first receipt time and the second receipt time; generating a log of sequences based on the remapped first metadata and the second metadata; receiving a request for one of the first locations or the second locations; and providing one of the first metadata or the second metadata in response to receiving the request.

In Example 2, the subject matter of Example 1 includes, wherein the first send time occurs before the second send time and the second receipt time occurs before the first receipt time and remapping the first metadata and the second metadata comprises resequencing the first metadata and the second metadata such that the second metadata is ahead of the first metadata in the log of sequences based on the second receipt time occurring before the first receipt time.

In Example 3, the subject matter of Examples 1-2 includes, wherein the object storage service is siloed from the background platform and the instructions further cause the system to perform operations comprising storing the first metadata and the second metadata at the background platform such that the first content and the second content are remotely stored from the first metadata and the second metadata.

In Example 4, the subject matter of Example 3 includes, wherein in response to receiving the request for the one of the first locations or the second locations, the instructions further cause the distributed platform to perform operations comprising: retrieving, at the background platform, one of the first content or the second content from the object storage service; and providing, at the background platform, the one of the first content or the second content to a requestor of one of the first content or the second content.

In Example 5, the subject matter of Examples 1-4 includes, wherein the background platform is logically separate from the distributed platform and the object storage service, the background platform being configured to scan, catalog, and periodically update the first or the second metadata in real time.

In Example 6, the subject matter of Examples 1-5 includes, wherein: the distributed platform comprises a metadata plane; and the metadata plane comprises a storage system having a key value store, keys associated with the key value store corresponding to data streams that comprise the data, values associated with the key value store indicating where on the object storage service the data streams corresponding to the keys are stored.

In Example 7, the subject matter of Examples 1-6 includes, wherein the first timestamp is different from the first receipt time.

In Example 8, the subject matter of Examples 1-7 includes, wherein the second timestamp is different from the second receipt time.

In Example 9, the subject matter of Examples 1-8 includes, wherein the first content is stored at the object storage service using a first type of storage service and the second content is stored at the object storage service using a second type of storage service different from the first type of storage service.

Example 10 is a method of operating a distributed platform comprising an object storage service, a distributed platform communicatively coupled with the object storage service, and a background platform communicatively coupled with the object storage service, the method comprising: receiving first metadata at the background platform at a first receipt time, the first metadata comprising: first pointers relating to first locations of first content stored at the object storage service; and a first timestamp corresponding to a first send time at which the first metadata was sent to the background platform; receiving second metadata at the background platform at a second receipt time different from the first receipt time, the second metadata comprising: second pointers relating to second locations of second content stored at the object storage service; and a second timestamp corresponding to a second send time at which the second metadata was sent to the background platform; remapping the first metadata and the second metadata based on the first receipt time and the second receipt time; generating a log of sequences based on the remapped first metadata and the second metadata; receiving a request for one of the first locations or the second locations; and providing one of the first metadata or the second metadata in response to receiving the request.

In Example 11, the subject matter of Example 10 includes, wherein the first send time occurs before the second send time and the second receipt time occurs before the first receipt time and remapping the first metadata and the second metadata comprises resequencing the first metadata and the second metadata such that the second metadata is ahead of the first metadata in the log of sequences based on the second receipt time occurring before the first receipt time.

In Example 12, the subject matter of Examples 10-11 includes, wherein the object storage service is siloed from the background platform and the method further comprises storing the first metadata and the second metadata at the background platform such that the first content and the second content are remotely stored from the first metadata and the second metadata and wherein in response to receiving the request for the one of the first locations or the second locations, the method further comprises: retrieving, at the background platform, one of the first content or the second content from the object storage service; and providing, at the background platform, the one of the first content or the second content to a requestor of one of the first content or the second content.

In Example 13, the subject matter of Examples 10-12 includes, wherein the background platform is logically separate from the distributed platform and the object storage service, the background platform configured to scan, catalog, and periodically update the first or the second metadata in real time.

In Example 14, the subject matter of Examples 10-13 includes, wherein: the distributed platform comprises a metadata plane; and the metadata plane is a storage system having a key value store where keys associated with the key value store corresponding to data streams that comprise the data and values associated with the key value store indicating where on the object storage service the data streams corresponding to the keys are stored.

In Example 15, the subject matter of Examples 10-14 includes, wherein the first content is stored at the object storage service using a first type of storage service and the second content is stored at the object storage service using a second type of storage service different from the first type of storage service.

Example 16 is a machine-storage medium having instructions embodied thereon, the instructions executable by at least one hardware processor to perform operations comprising: receiving first metadata at a background platform at a first receipt time, the first metadata comprising: first pointers relating to first locations of first content stored at the object storage service; and a first timestamp corresponding to a first send time at which the first metadata was sent to the background platform; receiving second metadata at the background platform at a second receipt time different from the first receipt time, the second metadata comprising: second pointers relating to second locations of second content stored at an object storage service; and a second timestamp corresponding to a second send time at which the second metadata was sent to the background platform; remapping the first metadata and the second metadata based on the first receipt time and the second receipt time; generating a log of sequences based on the remapped first metadata and the second metadata; receiving a request for one of the first locations or the second locations; and providing one of the first metadata or the second metadata in response to receiving the request.

In Example 17, the subject matter of Example 16 includes, wherein the first send time occurs before the second send time and the second receipt time occurs before the first receipt time and remapping the first metadata and the second metadata comprises resequencing the first metadata and the second metadata such that the second metadata is ahead of the first metadata in the log of sequences based on the second receipt time occurring before the first receipt time.

In Example 18, the subject matter of Examples 16-17 includes, wherein the object storage service is siloed from the background platform and the method operations further comprise storing the first metadata and the second metadata at the background platform such that the first content and the second content are remotely stored from the first metadata and the second metadata and wherein in response to receiving the request for the one of the first locations or the second locations, the operations further comprise: retrieving, at the background platform, one of the first content or the second content from the object storage service; and providing, at the background platform, the one of the first content or the second content to a requestor of one of the first content or the second content.

In Example 19, the subject matter of Examples 16-18 includes, wherein the background platform is logically separate from the background platform and the object storage service, the background platform configured to scan, catalog, and periodically update the first or the second metadata in real time.

In Example 20, the subject matter of Examples 16-19 includes, wherein: the background platform comprises a metadata plane; and the metadata plane is a storage system having a key value store where keys associated with the key value store corresponding to data streams that comprise the data and values associated with the key value store indicating where on the object storage service the data streams corresponding to the keys are stored.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

1. A distributed platform comprising:
an object storage service;
a distributed platform communicatively coupled with the object storage service; and
a background platform communicatively coupled with the object storage service, the background platform comprising:
at least one processor; and
at least one memory comprising instructions that, when executed by the at least one processor, cause the at least one processor to perform operations comprising:
receiving first metadata at the background platform at a first receipt time, the first metadata comprising:
first pointers relating to first locations of first content stored at the object storage service; and
a first timestamp corresponding to a first send time at which the first metadata was sent to the background platform;
receiving second metadata at the background platform at a second receipt time different from the first receipt time, the second metadata comprising:
second pointers relating to second locations of second content stored at the object storage service; and
a second timestamp corresponding to a second send time at which the second metadata was sent to the background platform;
remapping the first metadata and the second metadata based on the first receipt time and the second receipt time;
generating a log of sequences based on the remapped first metadata and the second metadata;
receiving a request for one of the first locations or the second locations; and
providing one of the first metadata or the second metadata in response to receiving the request.

2. The distributed platform of claim 1, wherein the first send time occurs before the second send time and the second receipt time occurs before the first receipt time and remapping the first metadata and the second metadata comprises resequencing the first metadata and the second metadata such that the second metadata is ahead of the first metadata in the log of sequences based on the second receipt time occurring before the first receipt time.

3. The distributed platform of claim 1, wherein the object storage service is siloed from the background platform and the instructions further cause the system to perform operations comprising storing the first metadata and the second metadata at the background platform such that the first content and the second content are remotely stored from the first metadata and the second metadata.

4. The distributed platform of 3, wherein in response to receiving the request for the one of the first locations or the second locations, the instructions further cause the distributed platform to perform operations comprising:
retrieving, at the background platform, one of the first content or the second content from the object storage service; and
providing, at the background platform, the one of the first content or the second content to a requestor of one of the first content or the second content.

5. The distributed platform of claim 1, wherein the background platform is logically separate from the distributed platform and the object storage service, the background platform being configured to scan, catalog, and periodically update the first or the second metadata in real time.

6. The distributed platform of claim 1, wherein:
the distributed platform comprises a metadata plane; and
the metadata plane comprises a storage system having a key value store, keys associated with the key value store corresponding to data streams that comprise the data, values associated with the key value store indicating where on the object storage service the data streams corresponding to the keys are stored.

7. The distributed platform of claim 1, wherein the first timestamp is different from the first receipt time.

8. The distributed platform of claim 1, wherein the second timestamp is different from the second receipt time.

9. The distributed platform of claim 1, wherein the first content is stored at the object storage service using a first type of storage service and the second content is stored at the object storage service using a second type of storage service different from the first type of storage service.

10. A method of operating a distributed platform comprising an object storage service, a distributed platform communicatively coupled with the object storage service, and a background platform communicatively coupled with the object storage service, the method comprising:
receiving first metadata at the background platform at a first receipt time, the first metadata comprising:
first pointers relating to first locations of first content stored at the object storage service; and
a first timestamp corresponding to a first send time at which the first metadata was sent to the background platform;
receiving second metadata at the background platform at a second receipt time different from the first receipt time, the second metadata comprising:
second pointers relating to second locations of second content stored at the object storage service; and
a second timestamp corresponding to a second send time at which the second metadata was sent to the background platform;
remapping the first metadata and the second metadata based on the first receipt time and the second receipt time;
generating a log of sequences based on the remapped first metadata and the second metadata;
receiving a request for one of the first locations or the second locations; and
providing one of the first metadata or the second metadata in response to receiving the request.

11. The method of claim 10, wherein the first send time occurs before the second send time and the second receipt time occurs before the first receipt time and remapping the first metadata and the second metadata comprises resequencing the first metadata and the second metadata such that the second metadata is ahead of the first metadata in the log of sequences based on the second receipt time occurring before the first receipt time.

12. The method of claim 10, wherein the object storage service is siloed from the background platform and the method further comprises storing the first metadata and the second metadata at the background platform such that the first content and the second content are remotely stored from the first metadata and the second metadata and wherein in response to receiving the request for the one of the first locations or the second locations, the method further comprises:
retrieving, at the background platform, one of the first content or the second content from the object storage service; and
providing, at the background platform, the one of the first content or the second content to a requestor of one of the first content or the second content.

13. The method of claim 10, wherein the background platform is logically separate from the distributed platform and the object storage service, the background platform configured to scan, catalog, and periodically update the first or the second metadata in real time.

14. The method of claim 10, wherein:
the distributed platform comprises a metadata plane; and
the metadata plane is a storage system having a key value store where keys associated with the key value store corresponding to data streams that comprise the data and values associated with the key value store indicating where on the object storage service the data streams corresponding to the keys are stored.

15. The method of claim 10, wherein the first content is stored at the object storage service using a first type of storage service and the second content is stored at the object storage service using a second type of storage service different from the first type of storage service.

16. A machine-storage medium having instructions embodied thereon, the instructions executable by at least one hardware processor to perform operations comprising:
receiving first metadata at a background platform at a first receipt time, the first metadata comprising:
first pointers relating to first locations of first content stored at the object storage service; and
a first timestamp corresponding to a first send time at which the first metadata was sent to the background platform;
receiving second metadata at the background platform at a second receipt time different from the first receipt time, the second metadata comprising:
second pointers relating to second locations of second content stored at an object storage service; and
a second timestamp corresponding to a second send time at which the second metadata was sent to the background platform;
remapping the first metadata and the second metadata based on the first receipt time and the second receipt time;
generating a log of sequences based on the remapped first metadata and the second metadata;
receiving a request for one of the first locations or the second locations; and
providing one of the first metadata or the second metadata in response to receiving the request.

17. The machine-storage medium of claim 16, wherein the first send time occurs before the second send time and the second receipt time occurs before the first receipt time and remapping the first metadata and the second metadata comprises resequencing the first metadata and the second metadata such that the second metadata is ahead of the first metadata in the log of sequences based on the second receipt time occurring before the first receipt time.

18. The machine-storage medium of claim 16, wherein the object storage service is siloed from the background platform and the operations further comprise storing the first metadata and the second metadata at the background platform such that the first content and the second content are remotely stored from the first metadata and the second metadata and wherein in response to receiving the request for the one of the first locations or the second locations, the operations further comprise:
retrieving, at the background platform, one of the first content or the second content from the object storage service; and
providing, at the background platform, the one of the first content or the second content to a requestor of one of the first content or the second content.

19. The machine-storage medium of claim 16, wherein the background platform is logically separate from the background platform and the object storage service, the background platform configured to scan, catalog, and periodically update the first or the second metadata in real time.

20. The machine-storage medium of claim 16, wherein:
the background platform comprises a metadata plane; and
the metadata plane is a storage system having a key value store where keys associated with the key value store corresponding to data streams that comprise the data and values associated with the key value store indicating where on the object storage service the data streams corresponding to the keys are stored.
